(19) United States
(12) Patent Application Publication
(10) Pub. No.: US 2026/0033700 A1
(43) Pub. Date: Feb. 5, 2026

(54) HINGE FOR DOORS

(71) Applicant: NUOVA STAR S.P.A., Zola Predosa (Bologna) (IT)

(72) Inventors: Marco VANINI, Zola Predosa (BO) (IT); Luca VANINI, Zola Predosa (BO) (IT)

(21) Appl. No.: 19/269,115

(22) Filed: Jul. 15, 2025

(30) Foreign Application Priority Data
Aug. 2, 2024 (IT) 102024000018265

(51) Int. Cl. A47L 15/42; E05D 7/06

(52) U.S. Cl. CPC A47L 15/4261; E05D 7/06; E05Y 2201/47; E05Y 2600/10; E05Y 2900/304

(57) ABSTRACT

A hinge for dishwasher doors, including a first element and a second element pivoted together and mutually movable in a tilting fashion, the first and second elements being fixable one to a frame and the other to a door of an electrical appliance to make the door movable with respect to the frame between a closed position and an open position, a lever connecting the first and the second element, an elastic element connected to the lever and capable of generating, with its own deformation, an elastic reaction force capable of at least partially compensating for the weight of the door during its opening or closing, as well as means for regulating the intensity of this elastic reaction force.

This application claims priority to Italian Patent Application 102024000018265 filed Aug. 2, 2024, the entirety of which is incorporated by reference herein.

The present invention concerns a hinge for doors of dishwashers.

In particular, the present invention concerns a hinge for doors of dishwashers also intended to support additional covering elements such as panels or the like.

By way of non-limiting example, the present invention will be described in the following with reference to a front-opening dishwasher.

The hinges used for doors of dishwashers are normally made up of two elements kinematically connected to each other to move reciprocally in tilting fashion, and with a first of these elements fixed to the door and a second of these elements fixed to the frame of the dishwasher.

Between the aforementioned first and second elements, a lever is normally interposed on which elastic elements act to dynamically affect the opening/closing of the door.

Substantially, the main function of the elastic elements acting on the lever is to counteract the weight force of the door and obtain a substantial balancing of the same, so as to keep it stably open at any opening angle and, above all, to prevent their own weight from causing it to fall once opened.

In recent years, devices have been developed for the automatic opening of dishwasher doors with the aim of facilitating the drying of dishes after the rinsing phase.

In fact, also by virtue of the high temperatures of the rinsing water used in normal washing cycles, opening the door at a specific moment at the end of the washing cycle allows the escape of water vapor, preventing it from condensing on the dishes themselves when they cool down.

There are many ways to open the doors and among the most common are those that include a motorized actuator that at the end of the washing cycle opens the door slightly with an angle of a few degrees, normally less than 10° sexagesimal, in order to allow the escape of steam.

This solution is certainly effective but is also very expensive, requiring a special actuator and the necessary mechanical connections with the door.

Other solutions include a snap opening of the door advantageously obtained following the compression of an elastic element upon closing of the door.

In this case, it is not easy to adjust the thrust needed to obtain the desired opening of the door, which is normally constrained by balanced hinges. Furthermore, the stroke of the door following the thrust received from the snap device can also depend on the weight of the covering panel placed on the door, a weight that varies greatly depending on the specific furniture in which the dishwasher is inserted.

These solutions therefore have the drawback of not guaranteeing the desired degree of door opening.

It is therefore an object of the present invention to provide an hinge for doors capable of overcoming the drawbacks of the known art and which is at the same time simple and economical to produce as well as user-friendly.

A further object of the present invention is to provide a structurally simple door hinge.

According to the invention, these objects and others are achieved by a door hinge comprising the technical characteristics described in the attached claims.

The technical characteristics of the invention, according to the aforementioned objects, are clearly described in the attached claims and its advantages are evident from the detailed description that follows, with reference to the attached drawings which illustrate an exemplary and non-limiting embodiment thereof, in which:

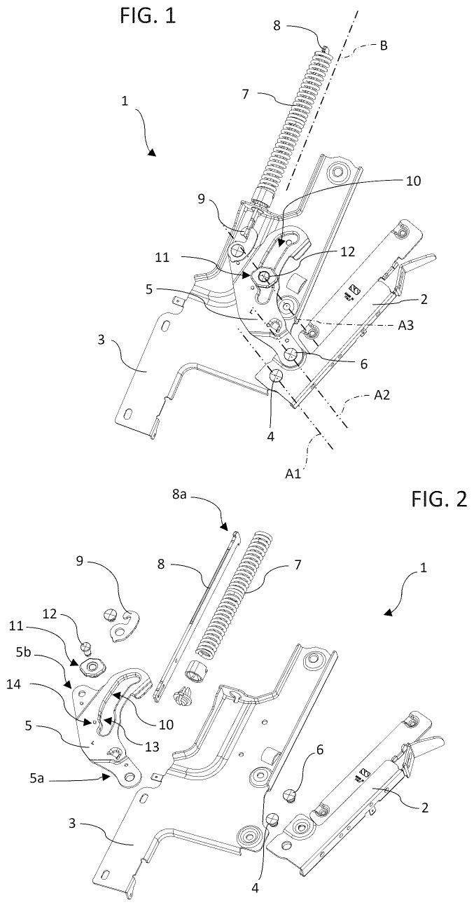

FIG. 1 illustrates, in a schematic perspective view, in a partially open position, a door hinge according to the present invention;

FIG. 2 represents an exploded perspective view of the hinge of FIG. 1;

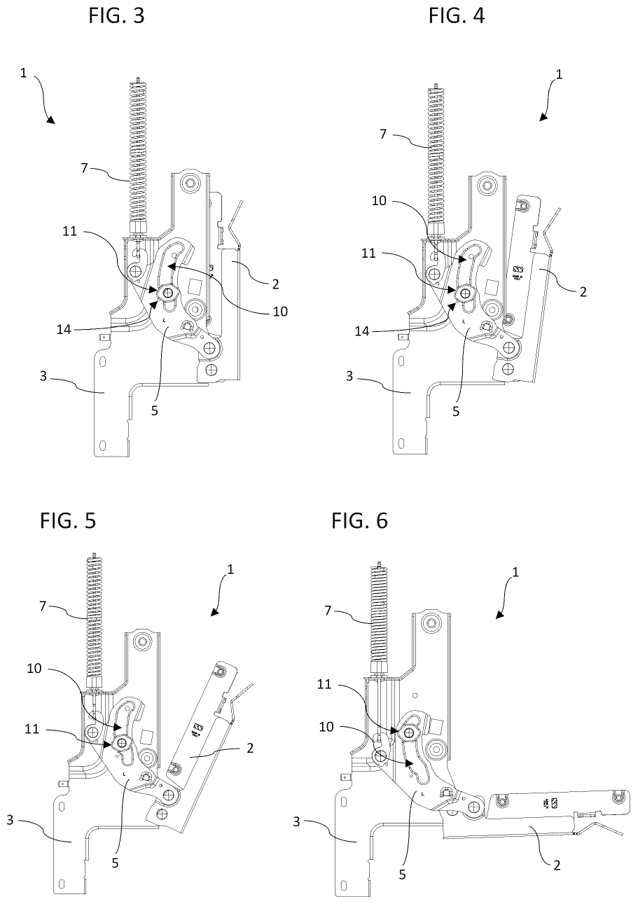

FIG. 3 represents, in a respective schematic view in lateral elevation, the hinge of FIG. 1 in a first different configuration of use;

FIG. 4 represents, in a respective schematic view in lateral elevation, the hinge of FIG. 1 in a second configuration of use;

FIG. 5 represents, in a respective schematic view in lateral elevation, the hinge of FIG. 1 in a third configuration of use;

FIG. 6 represents, in a respective schematic view in lateral elevation, the hinge of FIG. 1 in a fourth configuration of use;

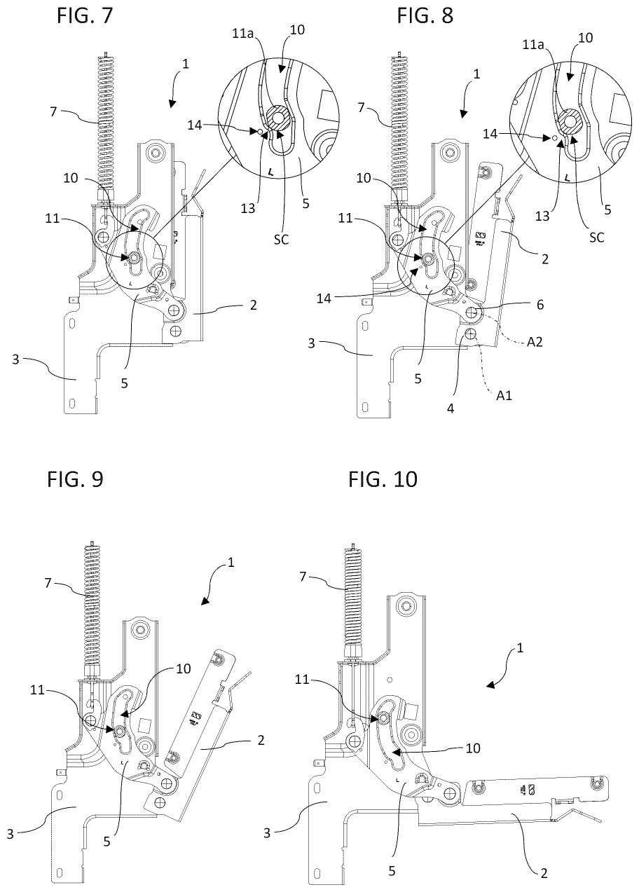

FIG. 7 shows the same view as FIG. 3 with a part removed to better highlight others;

FIG. 8 shows the same view as FIG. 4 with a part removed to better highlight others;

FIG. 9 shows the same view as FIG. 5 with a part removed to better highlight others;

FIG. 10 shows the same view as FIG. 6 with a part removed to better highlight others;

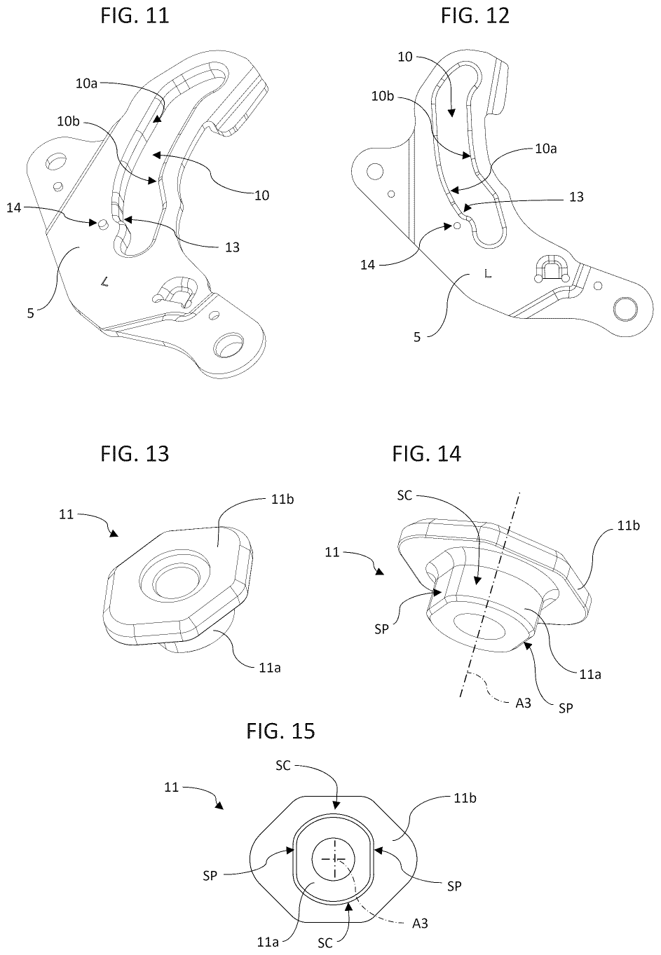

FIG. 11 shows, in a respective schematic perspective view, a detail of the hinge shown in the previous figures;

FIG. 12 shows, in a respective schematic perspective view from a different angle, a detail of the hinge shown in the previous figures;

FIG. 13 shows, in a respective schematic perspective view, a detail of the hinge shown in the previous FIGS. 1 to 6;

FIG. 14 shows, in a respective schematic perspective view from a different angle, a detail of the hinge shown in the previous FIGS. 1 to 6;

FIG. 15 illustrates, in a plan view from below, the detail shown in FIGS. 13 and 14.

As illustrated in FIG. 1, the reference number 1 indicates as a whole an embodiment of the hinge for doors according to the present invention.

The hinge 1 is intended to be mounted in pairs on a dishwasher to connect its frame to one of its doors, both not illustrated, so that the latter is movable in a tilting fashion with respect to the frame itself and in other words the door comes to be movable in a tilting fashion with respect to the frame between a closed position and an open position and vice versa.

With reference to the attached figures, the hinge 1 comprises a first element 2 suitable for being fixed to the aforementioned and not illustrated dishwasher door, and a second box-shaped element 3 fixed to the aforementioned and not illustrated dishwasher frame. The first element 2 is pivoted on the second element 3 by means of a pin 4 to allow the mutual rotation of the first and second elements 2, 3 around a respective rotation axis A1.

The rotation axis A1 defines the rotation axis of the aforementioned and not illustrated door with respect to the aforementioned and not illustrated frame.

The aforementioned first and second elements 2, 3 are kinematically connected to each other by means of a connecting lever 5.

At its first lower end 5a, the connecting lever 5 is pivoted on the first element 2 by means of a pin 6, so as to rotate at least partially with respect to the first element 2 itself around a respective axis A2.

The hinge 1 also comprises a helical spring 7 and a control rod 8 for the spring 7 itself, both supported by the second box-shaped element 3.

The control rod 8 is engaged at the bottom with a hook 9.

The hook 9 is pivoted on the lever 5 at its second end 5b, opposite to the aforementioned first end 5a.

The control rod 8 of the spring 7 is advantageously positioned inside the spring 7 itself and connected to it at the top, in a known manner, so as to compress it according to methods which are also substantially known.

In other words, as illustrated in FIG. 2, the control rod 8 has an upper end 8a longitudinally opposite to that hooked to the lever 5, which upper end 8a is able to engage with an upper end coil of the spring 7 to compress the spring 7 itself.

The spring 7 and the rod 8 develop according to a direction B of prevalent development of the second box-shaped element 3.

The spring 7 defines, for the hinge 1, a respective elastic element able to generate, with its own deformation, an elastic reaction force able to compensate at least partially the weight force of the door during its opening or closing.

A slot 10 is obtained on the connecting lever 5.

The slot 10 has an elongated development and has its own internal peripheral edges 10a, 10b counter-faced to engage slidingly with a guide pin 11, made integral with the second element 3 by means of a rivet 12. Specifically, the guide pin 11 is rotatably connected to the second box-shaped element 3, to oscillate around its own central axis A3.

According to variant embodiments not illustrated but falling within the same inventive concept, the guide pin is mounted on the lever and the slot obtained on the second element 3.

With particular reference to FIGS. 11 and 12, at a lower end of the slot 10, on the peripheral edge 10a a groove 13 is obtained defining a flex in the development of the peripheral edge 10a itself.

In other words, in the vicinity of the aforementioned groove 13, the peripheral edge 10a of the slot 10 shows a change in convexity.

In practice, the aforementioned groove 13 constitutes a recess in the peripheral edge 10a, which recess is configured to define, as will be better described below, a stable equilibrium position, at least under certain circumstances, for the guide pin 11 in its relative movement with respect to the slot 10.

As illustrated in detail in FIGS. 13 to 15, the guide pin 11 comprises a central body 11a and a head 11b, superimposed on the central body 11a and emerging radially with respect to it as will be better detailed below.

The head 11b has an approximately polygonal shape, with straight perimeter sides connected to each other by means of rounded edges.

According to the concept as set forth above, it is meant that the head 11b extends on a plane perpendicular to the central axis A3 of the pin 11, outside the cylinder in which the central body 11a is inscribed.

The central body 11a has two flat faces SP, parallel to each other and to the central axis A3 of the pin 11. Furthermore, as illustrated in FIGS. 14 and 15, the aforementioned flat faces SP of the central body 11a are arranged symmetrically on opposite sides of the central axis A3 of the pin 11, each of these flat faces SP being able to slide along a respective peripheral edge 10a, 10b of the slot 10.

Also with reference to FIGS. 14 and 15, the central body 11a of the pin 11 has two cylindrical surfaces SC connecting the aforementioned two parallel flat faces SP.

For the purposes of this discussion, the term cylindrical surfaces means two portions of the external surface of a cylinder, such portions being arranged diametrically opposite each other and being identified starting from a cylinder cut with two planes parallel to each other and to the axis of the cylinder arranged from opposite sides of the axis of the cylinder itself, which coincides with the axis A3 of the pin 11, and placed at a distance from this axis that is less than the radius of the cylinder.

As illustrated in FIGS. 11 and 12, the hinge 1 has a pin 14 emerging from the connecting lever 5, in proximity to the aforementioned groove 13.

As will be better described below, the pin 14 is configured to engage with the aforementioned head 11b of the guide pin 11 to determine an at least partial rotation of the pin 11 itself around its central axis A3.

Advantageously, the connecting lever 5 is made of stamped sheet metal and the pin 14 is obtained by engraving, that is, by punching with a small-sized punch.

The hinges 1 illustrated and described here are to be understood, in use, as being applied in pairs on a household appliance that is, a dishwasher having a mobile flap door arranged at the lateral ends of such door.

With reference to FIGS. 3 and 7, the hinge 1 is shown in its closed configuration corresponding to a closed position of the door, not illustrated, of the dishwasher.

In use, as also shown in the enlarged scale circle of FIG. 7, starting from the closed configuration of FIG. 7, the opening movement of the dishwasher door, and therefore of the first element 2 of the hinge 1 integral with it, engages the lever 5 in contact with the central body 11a of the guide pin 11 and determines a partial rotation around its central axis A3 (counterclockwise with respect to FIGS. 1 to 10) until an opening angle of approximately 8° sexagesimal of the door is reached in the configuration represented in FIGS. 4 and 8.

As clearly visible in FIG. 8, the central body 11a of the pin 11 is arranged with a portion of its own cylindrical surface SC substantially adhering to the groove 13 of the slot 10.

In other words, a part of the cylindrical connecting surface SC of the guide pin 11 is arranged adjacent to the aforementioned groove 13 of the slot 10, groove 13 with respect to which this cylindrical SC surface is counter-shaped.

Advantageously, in fact, the radii of curvature of the groove 13 and of the cylindrical connecting surface SC are very similar or even substantially equal. The engagement of the guide pin 11 or, rather, of one of its cylindrical SC surfaces, with the groove 13 of the slot 10 results in a kind of jamming in the hinge opening movement, and to overcome this jamming additional force is required, for example, by a user. In practice, however, in combination with the elastic action exerted by the spring, a stable equilibrium position is determined for the hinge 1, which equilibrium position can be abandoned only following the application of a specific force.

Substantially, this feature of the hinge 1 is used to generate a semi-open condition of the dishwasher door to facilitate the escape of steam at the end of the dishwashing and drying phase.

Advantageously, for example with an electric control, the dishwasher door, not illustrated, is released from a closing member and, even just by the intervention of a preloaded elastic element, is pushed to open.

The presence of the groove 13, in combination with the guide pin 11 appropriately shaped according to the present invention, together with an effective adjustment of the opening force, causes the hinge to stop at a given opening angle, for example around the value of 8° sexagesimal, as illustrated in FIGS. 3 and 7, in order to allow the escape of the steam present inside the dishwasher.

Starting from this stable semi-opening condition, to continue with a wider opening of the door, the intervention of the user is necessary, who with a reduced force overcomes the equilibrium condition determined by the housing of the pin 11 inside the groove 13.

FIGS. 5 and 6 illustrate the following opening phases (not illustrated), of the hinge 1 and the door. The equilibrium condition described above, approximately around the value of 8° sexagesimal opening, if sought during the opening phase of the door, may instead create some inconveniences during its closing phase thus leading to an undesirable hindrance.

In order to overcome this drawback, the pin 14 has been designed which, by engaging with the head 11b of the guide pin 11, determines, during the closing phase, when the equilibrium position described above is exceeded, a rotation (clockwise with reference to the attached figures) of the pin 11 itself such as to allow it to overcome the equilibrium position determined by the groove 13 without jamming.

In other words, as clearly illustrated in FIGS. 8 and 7, in the relative enlarged scale circles, during the closing phase, starting from the position illustrated in FIG. 8 in which the central body 11a of the pin 11 is substantially housed in the groove 13, the engagement of the head 11b of the pin 11 with the pin 14 (engagement represented in FIGS. 4 and 3 in which the head 11b is visible) causes the central body 11a integral with it to perform a partial rotation (anticlockwise with reference to the illustrated figures) such as to determine a sort of rolling of one of its cylindrical surfaces SC on the lower edge of the groove 14 itself.

This sort of rolling, clearly illustrated in the enlarged scale circle of FIG. 7, allows to overcome that jamming of the pin 11 in the groove 14 which is instead sought during the opening phase of the door for the reasons stated above and which, if it were to remain also in the closing phase, would generate an unwanted discontinuity in the closing movement of the door.

The hinge 1 for doors according to the invention achieves the intended purposes and obtains important advantages.

A first advantage is given by the fact that by means of the hinge 1 according to the invention, it is advantageously possible to obtain a stable semi-open condition of the dishwasher door without the need to introduce complicated and expensive solutions.

A further advantage is given by the possibility of easily overcoming, during the door closing phase, this stable position, to obtain a substantially smooth movement without jamming.

1. A hinge for doors of dishwashers, comprising:
a first element and a second element pivoted to each other and movable relative to each other in tilting fashion, said first and second elements being fixable one to a frame and the other to a door of a dishwasher, to make the door movable with respect to the frame between a closed position and an open position,
a lever for connecting between said first and second elements, a slot being made on said lever,
an elastic element connected to said connecting lever and designed to generate, by means of its own deformation, an elastic reaction force designed to compensate at least partially the weight force of the door during its opening or closing,
a guide pin of said lever supported by one of said first and second elements, said guide pin slidably engaging inside said slot, characterised in that said guide pin oscillates about a respective central axis and comprises a central body having at least one flat face parallel to said axis, said flat face being designed to slide along an edge of said slot, and in that said slot has a groove for stably housing said central body of the guide pin, configured to define a position of equilibrium of said door between its closed and open positions.

2. The hinge according to claim 1, wherein said central body of the guide pin has two flat faces parallel to said central axis, positioned symmetrically on opposite sides of said central axis, each of said flat faces being designed to slide along a respective edge of said slot.

3. The hinge according to claim 2, wherein said central body of the guide pin has two cylindrical surfaces connecting said two flat parallel faces.

4. The hinge according to claim 3, wherein said housing groove has, at least for a relative stretch, a radius of curvature which substantially coincides with the radius of curvature of said cylindrical surfaces.

5. The hinge according to claim 1, wherein said guide pin has a head emerging radially relative to said central body.

6. The hinge according to claim 5, wherein said head emerging radially has a shape at least approximately polygonal.

7. The hinge according to claim 6, wherein it has a pin emerging from said connecting lever, said pin being configured to engage with said head of said guide pin to determine an at least partial rotation of the guide pin about its central axis.

8. The hinge according to claim 7, wherein said connecting lever is made of moulded sheet metal, wherein said pin is obtained by chasing.

9. A dishwasher comprising a door which can be opened in tilting fashion, wherein it comprises a pair of hinges according to claim 1.
